(19) United States
(12) Patent Application Publication
(10) Pub. No.: US 2023/0231787 A1
(43) Pub. Date: Jul. 20, 2023

(54) COMMUNICATION METHOD AND AN APPARATUS

(71) Applicant: HUAWEI TECHNOLOGIES CO., LTD., Shenzhen (CN)

(72) Inventors: Qufang HUANG, Shenzhen (CN); Yuejun WEI, Shanghai (CN); Weiqiang YANG, Shenzhen (CN); Nijun LI, Shanghai (CN)

(21) Appl. No.: 18/180,879

(22) Filed: Mar. 9, 2023

Related U.S. Application Data
(63) Continuation of application No. PCT/CN2020/115045, filed on Sep. 14, 2020.

(51) Int. Cl. H04L 43/0852; H04L 65/80

(52) U.S. Cl. CPC H04L 43/0852; H04L 65/80

(57) ABSTRACT

A communication method and an apparatus. A terminal device receives at least one video frame from a network device. The terminal device determines a video frame parameter based on the at least one video frame. The terminal device sends the video frame parameter to the network device.

### CROSS-REFERENCE TO RELATED APPLICATION

This application is a continuation of International Application No. PCT/CN2020/115045, filed on Sep. 14, 2020, the disclosure of which is hereby incorporated by reference in its entirety.

### BACKGROUND

In an extended reality (XR) service scenario, a sensor in a helmet may sense a location, an action change, and the like of a user, and generate user information including a field of view, a line of sight, a movement rate, and the like. The user information may be transmitted to an XR server in an uplink transmission manner. An uplink transmission path may be the helmet->a terminal device->a wireless network->the XR server. The XR server may generate new video data based on information such as the location and the line of sight of the user and a scenario in which the user is in a game or a real scene. The new video data may be transmitted to the helmet in a downlink transmission manner. A downlink transmission path may be the XR server->the wireless network->the terminal device->the helmet, and finally the foregoing video data is displayed to the user through the helmet. For example, the wireless network is a 3rd generation partnership project (3GPP) network, for example, a long term evolution (LTE) network or the 5th generation (5G) network. Because a data volume of video frames for downlink transmission is generally large, how to optimize a downlink transmission manner is a technical problem to be resolved in at least one embodiment.

### SUMMARY

Embodiments described herein provide a communication method and an apparatus. After receiving a downlink video frame, a terminal device feeds back a frame parameter of the downlink video frame to a network device, to optimize transmission of the downlink video frame.

According to a first aspect, a communication method is provided. The method is performed by a terminal device, or is performed by a component (a chip, a circuit, or the like) disposed in the terminal device. The method includes: The terminal device receives at least one video frame from a network device; the terminal device determines a video frame parameter based on the at least one video frame; and the terminal device sends the video frame parameter to the network device. Optionally, the terminal device reports a receiving status of the video frame, that is, the foregoing video frame parameter, by using a video frame as a granularity.

Through implementation of the foregoing method, the terminal device determines the video frame parameter based on the received video frame, and sends the video frame parameter to the network device, so that the network device learns of the receiving status of the downlink video frame, to optimize downlink transmission of the video frame.

In at least one embodiment, the video frame parameter includes at least one of the following: a spread delay parameter, a frame gap parameter, a packet loss parameter, a late parameter, and base layer and enhancement layer parameters.

Through implementation of the foregoing method, the video frame parameter reported by the terminal device intuitively and accurately displays the receiving status of the downlink video frame in different dimensions, so that the network device optimizes transmission of the downlink video frame.

Optionally, the spread delay parameter indicates at least one of the following: a spread delay of a first video frame, an average spread delay of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Through implementation of the foregoing method, the terminal device periodically reports the foregoing spread delay parameter, and/or report the spread delay parameter in different conditions. The reporting conditions or content of the reported spread delay parameter is corresponding or is not corresponding. On the terminal device side, content and/or a manner of reporting the spread delay parameter is flexibly set, to meet various reporting requirements.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Through implementation of the foregoing method, the network device learns of a status of a frame gap between downlink video frames. For example, in response to finding that a frame gap between video frames is unstable, the network device subsequently increases a size of a buffer to ensure that the video frames are sent at a same interval.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Through implementation of the foregoing method, the network device learns of a packet loss status of a downlink video frame. In response to the network device finding that there are a small quantity of video frames in which packet loss occurs, but once packet loss occurs, a plurality of packets are lost, the network device determines that a deep fading time of a wireless signal is long, and changes a new frequency band to send a video frame, and the like.

In at least one embodiment, the method further includes: The terminal device determines whether packet data convergence protocol PDCP sequence numbers SNs of data packets included in a received video frame are consecutive; and packet loss occurs in the video frame in response to PDCP SNs of the data packets included in the video frame received by the terminal device being non-consecutive.

Through implementation of the foregoing method, the terminal device determines, depending on whether the PDCP sequence numbers SNs are consecutive, whether packet loss occurs in the video frame. This is easy to implement.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

Through implementation of the foregoing method, the network device learns of a late status of a downlink video frame, to optimize transmission of the downlink video frame.

In at least one embodiment, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Through implementation of the foregoing method, in response to the network device finding that a time difference between a base layer and an enhancement layer of a same video frame being excessively large, a transmission interval between the two layers is reduced subsequently.

Optionally, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

Through implementation of the foregoing method, the network device adjusts, based on a reporting status of the terminal device, a redundancy rate of a base layer or an enhancement layer in a network coding process, and optimize transmission of a downlink video frame.

According to a second aspect, a communication method is provided. The method is performed by a network device or is performed by a component (a chip, a circuit, or the like) configured in the network device, and includes: The network device sends at least one video frame to a terminal device; and the network device receives a video frame parameter from the terminal device, where the video frame parameter is determined based on the at least one video frame. Optionally, the foregoing video frame parameter is reported by using a video frame as a granularity.

Through implementation of the foregoing method, the network device obtains a receiving status of a downlink video frame, to optimize a transmission process of the downlink video frame.

In at least one embodiment, the video frame parameter includes at least one of the following: a spread delay parameter, a frame gap parameter, a packet loss parameter, a late parameter, and base layer and enhancement layer parameters.

Through implementation of the foregoing method, the network device intuitively and accurately learns a receiving status of a downlink video frame in a plurality of dimensions, to optimize a transmission solution of the downlink video frame.

Optionally, the spread delay parameter indicates at least one of the following: a spread delay of a first video frame, spread delays of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Through implementation of the foregoing method, after learning of the foregoing spread delay parameter, the network device adjusts a scheduling policy according to a value of a spread delay. For example, in response to the spread delay being excessively large, more resources are scheduled for the terminal device, or a modulation and coding scheme (MCS) is adjusted, to improve user experience. in response to the spread delay beung excessively small, scheduling resources is reduced, or the MCS is adjusted, to save resources, and the like.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Through implementation of the foregoing method, in response to the network device finding that a frame gap between video frames is unstable, the network device subsequently increases a size of a buffer to ensure that the video frames are sent at a same interval.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Through implementation of the foregoing method, in response to the network device finding that there are a small quantity of video frames in which packet loss occurs, but once packet loss occurs, a plurality of packets are lost, the network device determines that a deep fading time of a wireless signal is long, and changes a new frequency band to send a video frame.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

In at least one embodiment, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Through implementation of the foregoing method, in response to the network device finding that a time difference between a base layer and an enhancement layer of a same video frame being excessively large, a transmission interval between the two layers is reduced subsequently.

In at least one embodiment, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

Through implementation of the foregoing method, the network device adjusts, based on a reporting status of the terminal device, a redundancy rate of a base layer or an enhancement layer in a network coding process, and optimize transmission of a downlink video frame.

According to a third aspect, an apparatus is provided. For beneficial effects, refer to the descriptions of the first aspect. The apparatus has a function of implementing the behavior in the method embodiment in the first aspect. The function is implemented by executing corresponding hardware or software. The hardware or the software includes one or more units corresponding to the foregoing functions. In at least one embodiment, the apparatus includes: a communication unit, configured to receive at least one video frame from a network device; and a processing unit, configured to determine a video frame parameter based on the at least one video frame, where the communication unit is further configured to send the video frame parameter to the network device. These units performs the corresponding functions in the method example in the first aspect. For details, refer to the detailed descriptions in the method example. Details are not described herein again.

According to a fourth aspect, an apparatus is provided. For beneficial effects, refer to the descriptions of the first aspect. The apparatus is the terminal device in the method in the first aspect, or is a chip disposed in the terminal device. The apparatus includes a communication interface and a processor, and optionally, further includes a memory. The memory is configured to store a computer program or instructions. The processor is coupled to the memory and the communication interface. In response to the processor executing the computer program or the instructions, the apparatus is enabled to perform the method performed by the terminal device in the method in the first aspect.

According to a fifth aspect, an apparatus is provided. For beneficial effects, refer to the descriptions of the second aspect. The apparatus has a function of implementing the behavior in the method embodiment in the second aspect. The function is implemented by executing corresponding hardware or software. The hardware or the software includes one or more units corresponding to the foregoing functions. In at least one embodiment, the apparatus includes: a communication unit, configured to send at least one video frame to a terminal device, where the communication unit is further configured to receive a video frame parameter from the terminal device, and the video frame parameter is determined based on the at least one video frame. Optionally, a processing unit is configured to optimize transmission of a downlink video frame according to the video frame parameter. These units performs the corresponding functions in the method example in the second aspect. For details, refer to the detailed descriptions in the method example. Details are not described herein again.

According to a sixth aspect, an apparatus is provided. For beneficial effects, refer to the descriptions of the second aspect. The apparatus is the network device in the second aspect, or a chip disposed in the network device. The apparatus includes a communication interface and a processor, and optionally, further includes a memory. The memory is configured to store a computer program or instructions. The processor is coupled to the memory and the communication interface. In response to the processor executing the computer program or the instructions, the apparatus is enabled to perform the method performed by the network device in the method embodiment in the second aspect.

According to a seventh aspect, a computer program product is provided. The computer program product includes computer program code. In response to the computer program code being run, the method performed by the terminal device in the first aspect is performed.

According to an eighth aspect, a computer program product is provided. The computer program product includes computer program code. In response to the computer program code being run, the method performed by the network device in the second aspect is performed.

According to a ninth aspect, a chip system is provided. The chip system includes a processor, configured to implement the function of the terminal device in the method in the first aspect. In at least one embodiment, the chip system further includes a memory, configured to store program instructions and/or data. The chip system includes a chip, or includes a chip and another discrete component.

According to a tenth aspect, a chip system is provided. The chip system includes a processor, configured to implement the function of the network device in the method in the second aspect. In at least one embodiment, the chip system further includes a memory, configured to store program instructions and/or data. The chip system includes a chip, or includes a chip and another discrete component.

According to an eleventh aspect, a computer-readable storage medium is provided. The computer-readable storage medium stores a computer program, and in response to the computer program running, the method performed by the terminal device in the first aspect is implemented.

According to a twelfth aspect, a computer-readable storage medium is provided. The computer-readable storage medium stores a computer program, and in response to the computer program running, the method performed by the network device in the second aspect is implemented.

According to a thirteenth aspect, a communication system is provided, including the apparatus according to the third aspect or the fourth aspect, and the apparatus according to the fifth aspect or the sixth aspect.

### BRIEF DESCRIPTION OF DRAWINGS

FIG. 1 is a schematic diagram of a network architecture according to at least one embodiment;

FIG. 2 is another schematic diagram of a network architecture according to at least one embodiment;

FIG. 3 is a schematic diagram of adjacent video frames according to at least one embodiment;

FIG. 4 is a schematic diagram of network coding according to at least one embodiment;

FIG. 5 is a flowchart of a communication method according to at least one embodiment;

FIG. 6 is another schematic diagram of adjacent video frames according to at least one embodiment;

FIG. 7 is a schematic diagram of a late video frame according to at least one embodiment;

FIG. 8 is a schematic diagram of a base layer and an enhancement layer according to at least one embodiment;

FIG. 9 is another schematic diagram of network coding according to at least one embodiment;

FIG. 10 is a schematic diagram of a structure of an apparatus according to at least one embodiment; and

FIG. 11 is a schematic diagram of another structure of an apparatus according to at least one embodiment.

### DESCRIPTION OF EMBODIMENTS

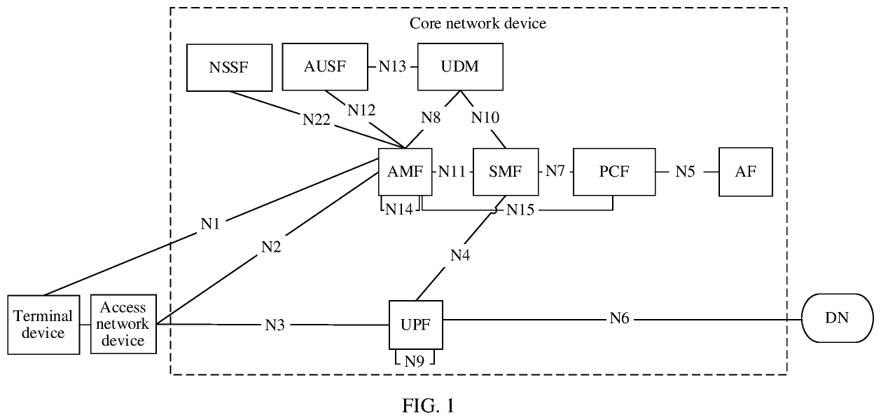

FIG. 1 is a schematic diagram of a network architecture to which at least one embodiment is applied. The network architecture includes at least one of a terminal device, an access network device, a core network (CN) device, and a data network (DN). The access network device and the core network device communicates with each other through a next generation (NG) interface, and different access network devices communicates with each other through an Xn interface.

1. Terminal Device

The terminal device is referred to as a terminal for short, and is a device having a wireless transceiver function. The terminal device is mobile or fixed. The terminal device is deployed on land, where the deployment includes indoor or outdoor, or handheld or in-vehicle deployment, is deployed on water (for example, on a ship), or is deployed in air (for example, on aircraft, a balloon, or a satellite). The terminal device is a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in a smart grid, a wireless terminal device in transportation safety, a wireless terminal device in a smart city, and/or a wireless terminal device in a smart home. Alternatively, the terminal device is a cellular phone, a cordless phone, a session initiation protocol (SIP) phone, a wireless local loop (WLL) station, a personal digital assistant (PDA), a handheld device or a computing device with a wireless communication function, an in-vehicle device, a wearable device, a terminal device in the 5th generation (5G) network, a terminal device in an evolved public land mobile network (PLMN), or the like. The terminal device is also referred to as user equipment (UE). The terminal device communicates with a plurality of access network devices using different technologies. For example, the terminal device communicates with an access network device supporting long term evolution (LTE), communicates with an access network device supporting 5G, or implements dual connectivity with an access network device supporting LTE and an access network device supporting 5G. This is not limited in at least one embodiment.

2. Access Network Device

The access network device is also referred to as a radio access network (RAN) device, is a device that connects a terminal device to a wireless network, and provides functions such as radio resource management, quality of service management, and data encryption and compression for the terminal device. The access network device includes but is not limited to:

a next generation NodeB (gNB), an evolved NodeB (eNB), a radio network controller (RNC), a NodeB (NB), a base station controller (BSC), a base transceiver station (BTS), a home base station (for example, a home evolved NodeB, or a home NodeB, HNB), a base band unit (BBU), a transmitting and receiving point (TRP), a transmitting point (TP), a mobile switching center, and/or the like in 5G. Alternatively, the access network device is a radio controller, a centralized unit (CU), and/or a distributed unit (DU) in a cloud radio access network (CRAN) scenario. Alternatively, the access network device is a relay station, an access point, an in-vehicle device, an access network device in a 5G network, an access network device in an evolved public land mobile network (PLMN), or the like.

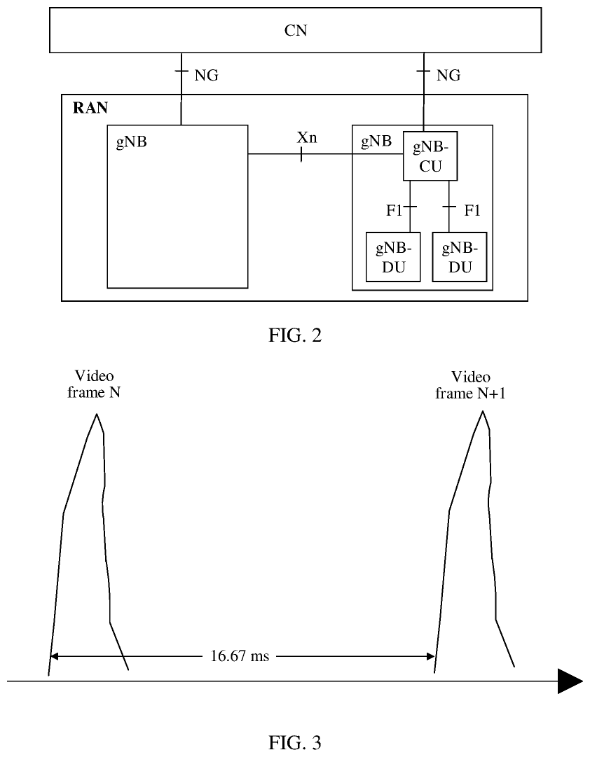

In some embodiments, as shown in FIG. 2, the access network device includes a centralized unit (CU) and a distributed unit (DU), and functions of the access network device is split. Some functions of the access network device are deployed on the CU, and the remaining functions are deployed on the DU. A plurality of DUs share one CU, thereby reducing costs and facilitating network expansion. Optionally, functions of the CU and the DU is classified based on protocol stacks. For example, a radio resource control (RRC) layer, a service data adaptation protocol (SDAP) layer, and a packet data convergence protocol (PDCP) layer are deployed on the CU. Other layers such as a radio link control (RLC) layer, a medium access control (MAC) layer, and a physical (PHY) layer are deployed on the DU. The CU and the DU is connected through an FI interface. The CU, representing the access network device, is connected to a core network through an NG interface, or the CU, representing the access network device, is connected to another access network device through an Xn interface. Further, functions of the CU is classified into:

(1) a centralized unit-control plane (CU-CP), mainly including control planes of an RRC layer and a PDCP layer on the CU; and

(2) a centralized unit-user plane (CU-UP), mainly including user planes of an SDAP layer and a PDCP layer on the CU.

3. Core Network Device

The core network device is mainly configured to manage a terminal device and provide a gateway for communication with an external network. The core network device includes one or more of the following network elements: an access and mobility management function (AMF) network element, a session management function (SMF) network element, a user plane function (UPF) network element, a policy control function (PCF) network element, an application function (AF) network element, a unified data management (UDM) network element, an authentication server function (AUSF) network element, and a network slice selection function (NSSF) network element. The AMF network element is mainly responsible for mobility management in a mobile network, such as user location update, user network registration, and user switching. The SMF network element is mainly responsible for session management in a mobile network, for example, session establishment, modification, and release. A specific function is, for example, allocating an IP address to a user, or selecting a UPF network element that provides a packet forwarding function. The UPF network element is mainly responsible for forwarding and receiving user data. During downlink transmission, the UPF network element receives user data from a data network (DN), and transmit the user data to a terminal device through an access network device. During uplink transmission, the UPF network element receives user data from a terminal device through an access network device, and forward the user data to the DN. Optionally, transmission resources and scheduling functions in the UPF network element that provide services for the terminal device is managed and controlled by an SMF network element. The PCF network element mainly supports providing a unified policy framework to control a network behavior, and providing a policy rule for a control plane network function, and is responsible for obtaining policy-related subscription information of the user. The AF network element mainly supports interaction with a wireless network, for example, a core network of a 3rd generation partnership project (3GPP) network, to provide a service, for example, affecting a data routing decision or a policy control function, or providing some third-party services for a network side. The UDM network element is mainly configured to generate an authentication credential, process a subscriber identifier (for example, store and manage a subscription permanent identifier), control access authorization, manage subscription data, and the like. The AUSF network element is mainly configured to perform authentication in response to the terminal device accessing a network, including receiving an authentication request sent by a security anchor function (SEAF), selecting an authentication method, requesting an authentication vector from an authentication repository and processing function (ARPF), and the like. The NSSF network element is mainly configured to: select a network slice instance for the terminal device, determine allowed network slice selection assistance information (NSSAI), configure the NSSAI, and determine an AMF set for serving the terminal device. In different communication systems, network elements or network element names in a core network is different. In the schematic diagram shown in FIG. 1, the 5^{th} generation mobile communication system is used as an example for description, and this is not intended to limit this application.

4. DN

The DN is a serving network that provides data services for users. For example, the DN is an IP multi-media service network or the Internet (Internet). The terminal device establishes a protocol data unit (PDU) session from the terminal device to the DN, to access the DN.

In some embodiments, an extended reality (XR) service provides an immersive multimedia experience for a user through interaction between user equipment (for example, a helmet) at an application layer and an XR application server. Optionally, the XR application server is located on the DN side in the framework shown in FIG. 1, and the helmet is located on the terminal device side in the architecture shown in FIG. 1. The helmet and the terminal device is integrated in a physical form, or is separated. This is not limited.

In an uplink transmission process, a sensor in the helmet senses a location, an action change, and the like of a user, and generate user information including a field of view, a line of sight, a movement rate, and the like. The helmet transmits the user information to the XR server through the terminal device, the access network device, the UPF network element, and the like in the architecture shown in FIG. 1.

In a downlink transmission process, the XR server generates a video frame with reference to the user information reported by the helmet and a scenario in which the user is in a game or a real scene. The XR server transmits the video frame to the helmet through the UPF network element, the access network device, the terminal device, and the like in the architecture shown in FIG. 1, and finally display the video frame to the user through the helmet. In the downlink transmission process, in response to the terminal device receiving a downlink video frame, how to feed back a receiving status of the video frame to the network device, to optimize transmission of the downlink video frame is a technical problem to be resolved in at least one embodiment.

Embodiments described herein provide a communication method and an apparatus. The method includes: A terminal device receives at least one video frame from an access network device; the terminal device determines a video frame parameter based on the at least one video frame; and the terminal device sends the video frame parameter to the access network device, so that the access network device learns of a receiving status of a downlink video frame, to optimize transmission of the downlink video frame.

For ease of understanding, communication nouns or terms used in at least one embodiment are explained and described.

1. XR Service Model Optionally, an XR Service Mainly Includes:

uplink service: user information generated by the helmet, including a user location and a line of sight, with a small data volume; and

downlink service: video frames generated by the XR server based on the user information reported by the helmet, with a large data volume.

As shown in FIG. 3, for the downlink service, the XR server generates video frames at a rate of 60 frames per second, that is, generates an original video frame every 16.67 ms. After the original video frames are encoded and compressed, different types of video frames are formed. For example, typical video frames includes an I frame, a P frame, a B frame, and the like. A size of each video frame range from 1000 kilobits (kbit) to 10000 kilobits (kbit). Optionally, for a video service, basic processing is to divide a video frame into N pictures per second, and each picture is encoded as a video frame. Because each video frame includes a large quantity of pixels, direct transmission occupies a large bandwidth. Therefore, the video service is compressed and then transmitted. Due to the nature of the video service, in response to the camera not being switched, content of most adjacent frames is the same, and only a small amount of content is different. Therefore, video frames is grouped, and a first frame of each group is a reference frame, and subsequent frames are dependent frames. During compression, intra-frame compression is performed on a reference frame, that is, during compression, only a data rate of the reference frame is referenced, and other frames are not referenced. In this way, after receiving a reference frame, a decompressor decompresses the reference frame independently without other frames. For a dependent frame after the reference frame, inter-frame compression is performed with reference to the reference frame, that is, during compression, both a data rate of the dependent frame and another frame such as the reference frame are referenced. In this way, a compression ratio is greatly improved during compression, and a size of compressed data is reduced. The reference frame is also referred to as an I frame, and has a largest size. The dependent frames include a P frame and a B frame, and have smaller sizes. The P frame refers to a frame that depends on only a previous frame during decoding, and the B frame refers to a frame that depends on both a previous frame and a subsequent frame during decoding.

In some embodiments, due to a network limitation, an encoded data stream is divided into a plurality of data packets according to a standard of 1500 bytes (considering packet header overheads, an actual data payload amount obtained through division is slightly less than 1500 bytes). From the perspective of a wireless network, downlink video data is represented as a cluster of downlink data packets received by the UPF from the XR server every 16.67 ms. A cluster of downlink data packets includes a plurality of data packets with a size of about 1500 bytes. The cluster of downlink data packets is a downlink video frame.

2. Layered Video Encoding

A size of an original video frame is excessively large. This imposes great pressure on a transmission network. Therefore, the video frame is compressed before transmission. A current compression manner generally achieves 300:1 compression efficiency, that is, a 300-megabit (Mbit) file is compressed to about 1 megabit (Mbit). However, as a resolution of a video frame is increasingly high, and chroma division is increasingly fine, a size of the video frame is increasingly large. According to the foregoing 300:1 compression efficiency, a compressed data volume still imposes excessively much pressure on the transmission network. Especially for the wireless network, because a capacity of the wireless network fluctuates greatly, in response to channel quality being poor, a data volume transmitted on a channel decreases correspondingly, a high-definition video frame cannot be transmitted, and a user experiences mosaics or even frame freezing.

Based on the foregoing case, layered video encoding is introduced, that is, in a compression coding process, information of a video frame is classified into two types: base layer data and enhancement layer data. In some embodiments, a ratio of data volumes of the two types of data is 1:9. In response to the channel capacity being small, in response to the user receives only the base layer data, the user obtains a low-resolution picture through a display, but no mosaic occurs. in response to the channel capacity being large, the user receives the base layer data and the enhancement layer data simultaneously to obtain a high-resolution picture. Compared with a high-definition video that is not layered, a sum of the data volumes of the base layer data and the enhancement layer data is greater than a data volume of the video that is not layered. The layered encoding manner is able to better cope with the fast change of radio channels, and reduce the frame freezing and mosaic, improving user experience.

In actual layered encoding, the foregoing enhancement layer includes one layer, or is divided into a plurality of layers. This is not limited. The more the layers, the more suitable the radio channels with different capacities.

3. Network Coding

Transmission errors occurs due to unstable radio channel statuses. Generally, retransmission is used for compensation. Retransmission solves the problem of error packets, but causes extra delay and low efficiency. For a real-time multimedia service, a large amount of data is transmitted, and in almost every slot, there are data packets to be transmitted. in response to an additional retransmitted data packet being inserted, data in each subsequent slot is delayed backward. This increases the delay. In addition, a data packet of a real-time multimedia service is generally large, and only a small part thereof is incorrect. in response to the entire data packet being retransmitted because a small part of the data packet is incorrectly transmitted, radio resources are wasted, and efficiency is reduced.

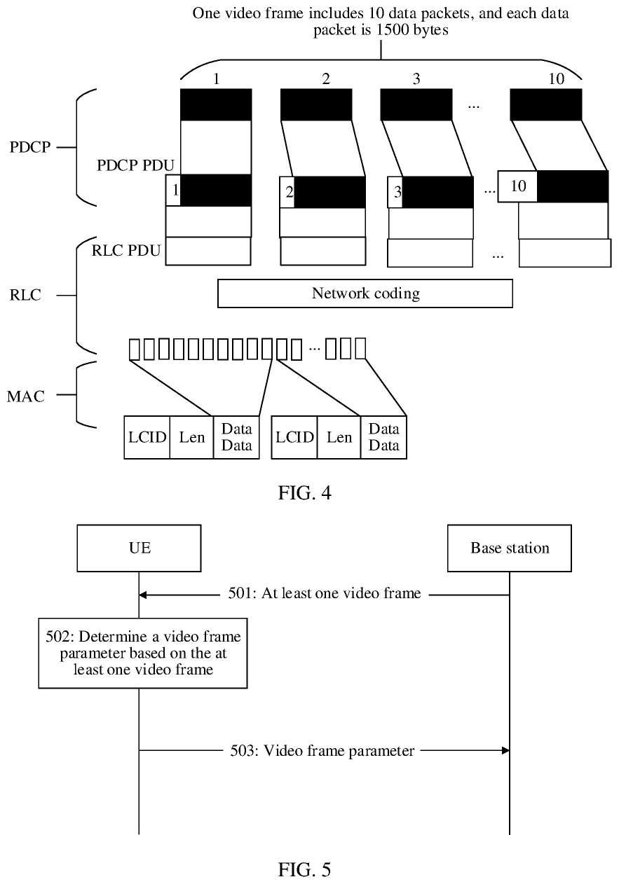

Based on the foregoing case, a network coding mechanism is introduced. The core idea of the network coding mechanism is to encode a group of data packets in a unified manner. In an example, as shown in FIG. 4, 10 data packets included in a video frame is grouped into a group, and unified network coding is performed. After the encoding, several small data blocks are output, and then the small data blocks are transmitted in batches based on an air interface status. After receiving all the small data blocks, a receiver decodes the entire data packet. In response to finding that a data packet cannot be correctly decoded, the sender is notified to further send some small data blocks. The small data blocks further sent by the sender are not the data blocks that have been transmitted previously, but small data blocks newly generated by a network coding module. The receiver decodes all the received small data blocks in a unified manner.

In some embodiments, as shown in FIG. 4, for each data packet, a PDCP PDU is generated after processing by a PDCP layer, and is transmitted to an RLC layer. After processing by the RLC layer, an RLC PDU is generated. Network coding is performed on the RLC PDU at the RLC layer to obtain several small data blocks, and the small data blocks are transmitted to the MAC layer. After processing by the MAC layer, a MAC PDU is obtained. Each MAC PDU includes fields such as a logical channel identifier (LCID), a length (Len), and data. Optionally, a small data block formed after network coding is also referred to as a data slice. In the following embodiment, a data slice is used as an example for description.

In the foregoing network coding manner, a real-time feedback mechanism does not need to be designed, and the sender does not retransmit the entire original data packet, thereby improving wireless transmission efficiency and reducing a transmission delay.

Unless otherwise specified, “I” in the descriptions of embodiments herein represents an “or” relationship between associated objects. For example, A/B represent A or B. In at least one embodiment, “and/or” describes only an association relationship for describing associated objects and represents that three relationships exist. For example, A and/or B represent the following three cases: Only A exists, both A and B exist, and only B exists. A and B is singular or plural. In addition, in descriptions of this application, unless otherwise specified, “a plurality of” means two or more than two. At least one of the following items (pieces) or a similar expression thereof refers to any combination of these items, including any combination of singular items (pieces) or plural items (pieces). For example, at least one item (piece) of a, b, or c indicate: a, b, c, a and b, a and c, b and c, or a, b, and c, where a, b, and c is singular or plural. In addition, to clearly describe the technical solutions in at least one embodiment, terms such as first and second are used in at least one embodiment to distinguish between same items or similar items that provide basically same functions or purposes. A person skilled in the art understands that the terms such as “first” and “second” do not limit a quantity or an execution sequence, and the terms such as “first” and “second” do not indicate a definite difference.

In addition, the network architecture and the service scenario described in at least one embodiment are intended to describe the technical solutions more clearly, and do not constitute a limitation on the technical solutions provided in at least one embodiment. A person of ordinary skill in the art know that: With the evolution of the network architecture and the emergence of new service scenarios, the technical solutions provided in at least one embodiment are also applicable to similar technical problems.

The network elements in at least one embodiment include an access network device, a terminal device, a helmet, an XR server, and the like. The access network device is of a CU/DU architecture. In this case, the access network device includes two network elements: a CU and a DU. Alternatively, the access network device is of a CP-UP architecture. In this case, the access network device includes three network elements: a CU-CP, a CU-UP, and a DU. Alternatively, the access network device is of an open radio access network (ORAN) architecture. In this case, the access network device includes four network elements: a CU-CP, a CU-UP, a DU, and a near real-time RAN intelligent controller, RIC (RIC), or even more network elements. Further, the DU is split into a DU-H, a DU-L, and the like, to support split of a lower layer, for example, a far-end physical layer. A network device (or a base station) in the following embodiment is a network element in an access network device, or includes a plurality of network elements in an access network device.

For ease of understanding, an example in which the terminal device is UE and the network device is a base station is used for description. As shown in FIG. 5, a procedure of a communication method is provided, including the following steps.

Step 501: UE receives at least one video frame from a base station. Optionally, as described above, each video frame includes one or more data packets, and a size of each data packet is approximately 1500 bytes. The data packet is also referred to as an Internet Protocol (IP) packet. The following uses the data packet as an example for description. Optionally, a data packet included in each video frame is video data, is video data and audio data, or the like. This is not limited.

Step 502: The UE determines a video frame parameter based on the at least one video frame.

Optionally, the UE determines the video frame parameter by using a video frame as a granularity.

Step 503: The UE sends the video frame parameter to a base station. Optionally, the UE reports the video frame parameter in the following manners:

Periodic reporting: The UE reports the video frame parameter every periodicity, and a reporting periodicity is configured by a base station, an SMF network element, an XR server, or the like. In response to the configuration being performed by the base station, the UE receives a configuration information element from the base station, where the configuration information element indicates a reporting periodicity; and the UE reports the video frame parameter according to the reporting periodicity indicated by the configuration information element. In response to the configuration being performed by the SMF network element or the XR server, the SMF network element or the XR server sends information about the reporting periodicity to the base station. The base station generates, based on the information, a configuration information element indicating the reporting periodicity, and sends the configuration information element to the UE. Alternatively, the base station directly sends the information about the reporting periodicity to the UE as the configuration information element. The UE reports the video frame parameter based on the reporting periodicity indicated by the configuration information element.

Condition-triggered reporting: in response to the UE finding that a reporting condition is met, the UE reports the video frame parameter once. The reporting condition is configured by the base station, the SMF network element, the XR service, or the like.

Periodicity+condition-triggered reporting: At the end of each periodicity, the UE takes statistics of video frame parameters, and determines whether a preset condition is met. in response to the preset condition being met, the video frame parameters are reported; otherwise, the video frame parameters are not reported. Similarly, the reporting periodicity and the reporting condition is configured by the base station, the SMF network element, the XR server, or the like.

A configuration manner of the reporting condition is the same as that of the reporting periodicity, and details are not described herein again. An object to which the UE reports the video frame parameter is a receiving object of the video frame parameter, and is a base station, or is a core network element, for example, an SMF or a UPF, or even is an XR server. Certainly, in response to the receiving object of the video frame parameter being a core network element, an XR server, or the like, the base station forwards the received video frame parameter to the core network element, the XR server, or the like. The foregoing description is provided by using an example in which there is one receiving object of the video frame parameter. Actually, there is also a plurality of receiving objects of the video frame parameter. For example, receiving objects of the video frame parameter includes a base station, a core network element, an XR server, and the like. After receiving the video frame parameter, each receiving object separately performs corresponding optimization. For example, after receiving the video frame parameter, the base station optimizes radio resource scheduling. After receiving the video frame parameter, the SMF network element optimizes a service configuration of the user. After receiving the video frame parameter, the UPF network element optimizes a forwarding priority of a data packet. After receiving the video frame parameter, the XR server optimizes a coding and/or compression manner of a downlink video frame, and the like.

The foregoing description that, in at least one embodiment, the UE obtains the video frame parameter based on the received video frame, to report the receiving status of the video frame, so that the network device intuitively and accurately obtains the receiving status of the video frame, to optimize a transmission solution of the video frame.

In a solution, for a video service, the UE reports a receiving status, for example, packet loss and/or a data packet delay, of each data packet by using a data packet as a granularity. This reporting manner is not accurate enough for video service statistics. The reasons are as follows: For example, in response to the UE losing two data packets, there is two cases.

Case 1: Two lost data packets are located in different video frames.

Case 2: Two lost data packets are located in a same video frame.

From the perspective of network performance, the foregoing two cases correspond to the same network performance, and quantities of lost data packets are the same. However, from the perspective of user experience, the foregoing two cases correspond to different user experience. For Case 1, the user continuously views two pictures with poor picture quality. For Case 2, the user views a picture with poor picture quality, and the next picture is very clear. The UE reports the receiving status of the data packet by using a data packet as a granularity, and reflecting the difference between the foregoing two cases is difficult. However, in at least one embodiment the UE reports the receiving status of the video frame by using a video frame as a granularity, so that the receiving status of the video frame is more accurately reflected, to optimize the entire video transmission solution.

Embodiment 1: In at least one embodiment, the video frame parameter reported by the UE includes at least one of the following:

1. Spread delay parameter: The spread delay parameter indicates at least one of the following: a spread delay of a first video frame, an average spread delay of a plurality of video frames, a maximum spread delay of a plurality of video frames, a minimum spread delay of a plurality of video frames, and a variance of spread delays of a plurality of video frames. The first video frame or the plurality of video frames are one or more video frames of the at least one video frame received by the UE.

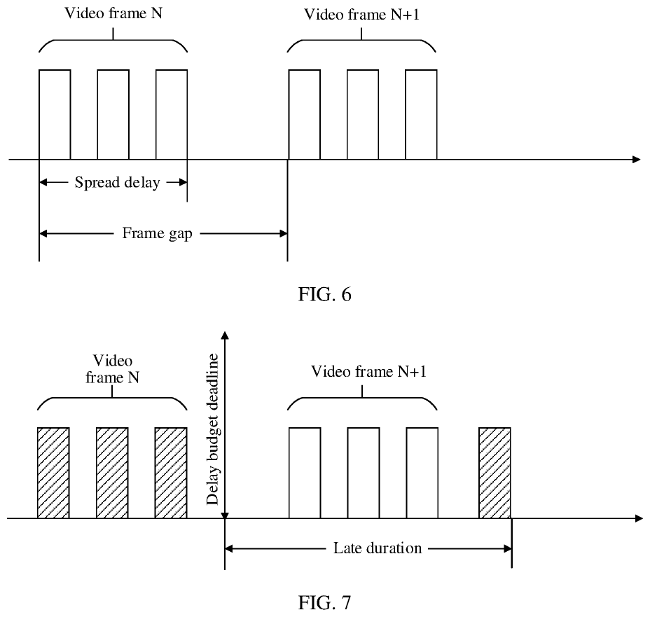

One picture is encoded, compressed, or the like to form one or more video frames, and each video frame is divided into a plurality of data packets. In this case, from the perspective of the UE, receiving one video frame is receiving a plurality of data packets. The spread delay is a time length from a time in response to the UE successfully receiving a first data packet of a video frame to a time in response to the UE successfully receiving a last data packet of the video frame. For example, as shown in FIG. 6, a video frame N is divided into three data packets, and a spread delay of the video frame N is specifically a time length from a time in response to the UE successfully receiving the first data packet of the video frame N to a time in response to the UE successfully receiving the third data packet of the video frame N.

In at least one embodiment, the UE takes statistics of a spread delay of each video frame, obtain and report an average value, a maximum value, a minimum value, a variance, or the like of the spread delays of the plurality of video frames based on the spread delays of the plurality of video frames. Alternatively, in at least one embodiment, the UE reports a spread delay of a single video frame, that is, a spread delay of the first video frame. This is not limited.

For example, a manner in which the UE reports the spread delay parameter includes any one of the following:

Periodic reporting: A reporting periodicity is configured by the base station, the SMF network element, or the XR service, and reporting is performed every periodicity.

Condition-triggered reporting: A reporting condition is configured by the base station, the SMF network element, or the XR server. in response to the UE finding that the reporting condition is met, reporting is performed once.

Periodicity+condition-triggered reporting: At the end of each periodicity, the UE takes statistics of a spread delay of each video frame in the periodicity and determines whether the preset reporting condition is met. in response to the reporting condition being met, the UE performs reporting; otherwise, the UE does not perform reporting. Similarly, the periodicity and the reporting condition is configured by the base station, the SMF network element, the XR server, or the like.

The foregoing reporting condition is set according to a requirement. This is not limited. The reporting condition corresponds to reported content. For example, the reporting condition includes that: in response to a spread delay of a single video frame being greater than or equal to a threshold A1, a spread delay parameter of the single video frame is reported; or the reporting condition includes that: in response to a spread delay of a single video frame being less than or equal to a threshold B1, a spread delay parameter of the single video frame is reported. For another example, the reporting condition includes that: in response to an average spread delay (that is, an average value of spread delays of a plurality of video frames) of the plurality of video frames being greater than or equal to a threshold A2, the average spread delay of the plurality of video frames is reported; or the reporting condition includes that: in response to an average spread delay of a plurality of video frames being less than or equal to a threshold B2, the average spread delay of the plurality of video frames is reported. This is the same for reporting of a maximum value, a minimum value, or a variance of spread delays of a plurality of video frames. Alternatively, the reporting condition do not correspond to reported content. For example, the reporting condition includes that: in response to a spread delay of a single video frame being greater than or equal to a threshold A3, an average spread delay of a plurality of video frames including the single video frame is reported; or the reporting condition includes that: in response to a spread delay of a single video frame being greater than or equal to a threshold B3, an average spread delay of a plurality of video frames including the single video frame is reported. The single video frame is a first video frame, an intermediate video frame, or a last video frame of the plurality of video frames, and a quantity of the plurality of video frames is preset. This is the same for reporting of a maximum value, a minimum value, or a variance of spread delays of a plurality of video frames. Values of the thresholds A1 to A3 and B1 to B3 are not limited, and is the same, or is different.

After learning of the spread delay parameter, the network device adjusts a scheduling policy according to a value of the spread delay. For example, in response to the spread delay being excessively large, more resources are scheduled for the UE, or a modulation and coding scheme (MCS) is adjusted, to improve user experience. in response to the spread delay being excessively small, scheduling resources is reduced, or the MCS is adjusted, to save resources.

2. Frame gap parameter: The frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps. The UE receives a plurality of video frames from the base station.

Optionally, the frame gap is also referred to as a video frame gap. Time differences between all adjacent video frames sent by a video encoder in an XR application server are the same. A specific value depends on a frame rate. For example, in the case of 60 frames per second, a time difference between two adjacent video frames is 16.67 ms. However, a time for a network to transmit each video frame is not completely the same, especially for a wireless network. Therefore, in response to receiving video frames, the UE does not receive a video frame every 16.67 ms. The UE determines a frame gap between two adjacent video frames according to reference locations of the two adjacent video frames, where the reference location is a start location, a middle location, an end location, any other locations, or the like. This is not limited. For example, the UE takes statistics of successful receiving moments of first data packets corresponding to two adjacent video frames, and calculate a time difference between the two receiving moments as a frame gap between the adjacent video frames. For example, as shown in FIG. 6, a video frame N and a video frame N+1 are adjacent video frames, and each include three data packets. The UE separately takes statistics of a moment at which a first data packet in the video frame N is successfully received and a moment at which a first data packet in the video frame N+1 is successfully received. A time difference between the two moments is a frame gap between the video frame N and the video frame N+1. Alternatively, the UE takes statistics of successful receiving moments of last data packets corresponding to two adjacent video frames, and calculate a time difference between the two receiving moments as a frame gap between the adjacent video frames.

3. Packet loss parameter: The packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

In response to the UE finding that packet loss occurs after receiving a plurality of data packets of a video frame, the video frame is considered as a “video frame in which packet loss occurs”. Specifically, the UE determines, through a PDCP sequence number (SN), whether packet loss occurs, and in response to PDCP SNs corresponding to the received data packets being non-consecutive, packet loss occurs. For example, a video frame includes M data packets, and PDCP SNs of the M data packets are sequentially 1 to M. In response to the UE receiving the M^{th} data packet, in response to the UE finding that a previous data packet whose PDCP SN is N is not received, PDCP SNs of the video frame are non-consecutive, and packet loss occurs in the video frame. Optionally, whether the foregoing PDCP SNs are consecutive is alternatively replaced with whether the PDCP SNs are lost, or the like. Specifically, the UE determines, at a moment at which an end marker of a video frame is received, whether packet loss occurs in the video frame; or determines, at a moment at which data packets corresponding to the video frame are submitted to an IP layer or a real-time transport protocol (RTP) layer, whether packet loss occurs in the video frame; or determines, at a moment at which the data packets corresponding to the video frame are played at an application layer, whether packet loss occurs in the video frame. This is not limited.

In some embodiments, within a period of time, the UE determines a quantity of video frames in which packet loss occurs, a proportion of the video frames in which packet loss occurs to total video frames within the period of time, and the like. For example, within a period of time, the UE receives a total of five video frames from the base station. in response to packet loss occurring in three video frames, a quantity of video frames in which packet loss occurs is 3, and a proportion of the video frames in which packet loss occurs is ⅗=60%. The UE further takes statistics, in video frames in which packet loss occurs, of a ratio of video frames with one data packet lost to all the video frames in which packet loss occurs, a ratio of video frames with two data packets lost to all the video frames in which packet loss occurs, a ratio of video frames with three data packets lost to all the video frames in which packet loss occurs, and the like. Still using the foregoing example, within a period of time, packet loss occurs in three video frames, where one data packet is lost in one video frame, and two data packets are lost in two video frames. In this case, a proportion of the video frame with one data packet lost to all the video frames in which packet loss occurs is ⅓=33.3%, and a proportion of the video frames with two data packets lost to all the video frames in which packet loss occurs is ⅔=66.7%. The UE further takes statistics of how many consecutive video frames in which packet loss occurs there are. For example, within a period of time, the UE receives 10 video frames from the base station, whose sequence numbers are sequentially 1 to 10. in response to packet loss occurring in video frame 1, no packet loss occurs in video frames 2 to 5, packet loss occurs in video frames 6 to 8, and no packet loss occurs in video frames 9 and 10, the UE reports that packet loss occurs in three consecutive video frames, that is, video frames 6 to 8.

4. Late parameter: The late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, a variance of time differences between actual receiving moments and correct receiving moments of a plurality of late video frames, and the like.

Because correlation between consecutive video frames is high, in a process of compressing a video frame, an encoder in the XR application server selects a video frame before the video frame as a reference frame for compression. As shown in FIG. 7, in response to some data packets in a video frame not being successfully transmitted within a predefined delay, the data packets are successfully transmitted after a delay budget. Although the video frame cannot be displayed through the display, the video frame is used as a reference frame of a subsequent video frame, and is still useful. The UE takes statistics of information such as a quantity of such video frames, a proportion of such video frames in all video frames, and how long a correct receiving moment is later than the delay budget, and report the information to the base station. In at least one embodiment, parameters specifically reported by the UE is: a quantity of late video frames within a period of time, a proportion of the late video frames, a time difference between an actual receiving moment and a correct receiving moment of a late video frame, a maximum value, a minimum value, a variance, or the like of time differences between actual receiving moments and correct receiving moments of a plurality of late video frames, and the like. This is not limited. For example, within a period of time, the UE receives 10 video frames from the base station, video frames 1 to 5 correctly arrive, and video frames 6 to 10 are late. In this case, a quantity of late video frames is 5, and a proportion of the late video frames is 5/10=50%. An actual arrival moment of video frame 6 is 15:05:35 on Aug. 28, 2020, and a correct arrival moment of video frame 6 is to be 15:05:20 on Aug. 28, 2020. In this case, a time difference between the actual arrival moment and the correct arrival moment of data packet 6 is 15 seconds. “An actual receiving moment and a correct receiving moment of a video frame” is defined in the following manner. The actual receiving moment of the video frame refers to a moment at which the UE receives all data packets corresponding to the video frame. An N^{th} video frame includes 10 data packets, and an actual receiving moment of the N^{th} video frame is a moment at which the UE receives all the 10 data packets of the N^{th} video frame. First, a correctly received video frame is defined. in response to all data packets of a video frame being received before a predefined moment, the video frame is considered as a correctly received video frame. in response to an i^{th} video frame being set to be correctly received, a correct receiving moment of an (i+M)^{th} video frame is: an actual receiving moment of a last data packet of the i^{th} video frame+M*a time difference between adjacent video frames. Optionally, the time difference between adjacent video frames is 16.67 ms, and M is a positive integer greater than or equal to 1.

In the foregoing description, an example in which a late video frame is defined as a video frame “that is received after the delay budget, but is still used as a reference frame of another video frame following the late video frame” is used for description. This is not intended to limit embodiments described herein. For example, in at least one embodiment, the late video frame is alternatively defined as “a video frame received after a first delay budget”, or “a video frame received after the first delay budget and before a second delay budget”, or “a video frame whose late duration meets a preset time requirement”.

5. Base Layer and Enhancement Layer Parameters

In response to layered video encoding being used, for example, a video is divided into a base layer and an enhancement layer, the UE receives data of two flows flow, two data radio bearers (DRB), or two data channels, base layer data and enhancement layer data. The UE separately takes statistics of data reception statuses of the two layers, and report one or more of the following parameters.

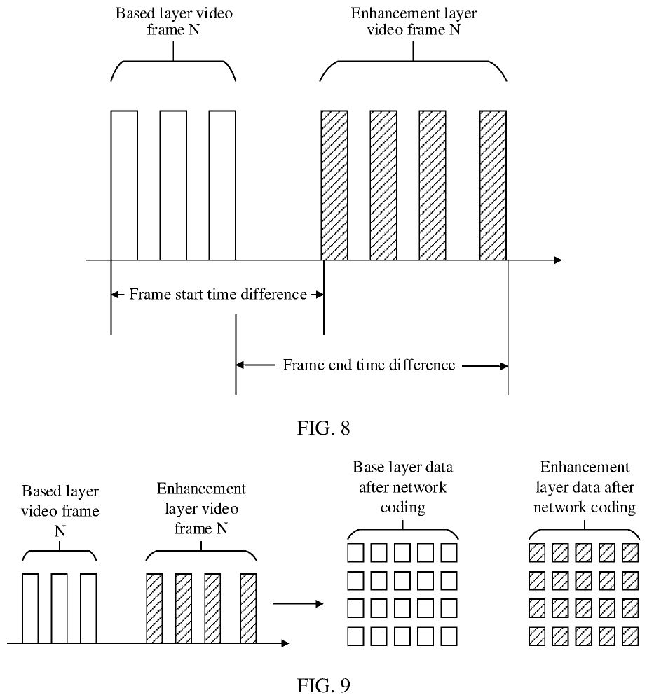

1. Time difference between a time in response to the UE receiving base layer data and a time in response to the UE receiving enhancement layer data in a same video frame. Optionally, the UE takes statistics of a time difference between a reference location in the base layer data and a reference location in the enhancement layer data in the same video frame. The reference location is a start frame location, an end frame location, a middle location, any location, or the like. This is not limited. As shown in FIG. 8, for a video frame N, a base layer includes three data packets, and an enhancement layer includes four data packets. A frame start time difference between the base layer and the enhancement layer of the video frame N is counted, or a frame end time difference between the base layer and the enhancement layer of the video frame N is counted, and the like. The UE reports a time difference between base layer data and enhancement layer data in a single video frame, or the UE reports an average value, a maximum value, a minimum value, a variance, or the like of time differences between base layer data and enhancement layer data in a plurality of video frames.

In the foregoing description, an example in which the video frame is divided into two layers is used for description. In practice, the video frame is further divided into three layers, four layers, or more layers. For example, in the case of three layers, the entire video frame is divided into a base layer, a first enhancement layer, and a second enhancement layer. For the case of four layers, the entire video frame is divided into a base layer, a first enhancement layer, a second enhancement layer, and a third enhancement layer. For example, the foregoing video frame is divided into three layers. The UE separately reports a time difference between first enhancement layer data and base layer data, a time difference between second enhancement layer data and the base layer data, and the like, and even reports a time difference between different enhancement layers. This is not limited.

2. A plurality of parameters selected from a quantity, a proportion, a quantity of lost packets, or the like of video frames in which packet loss does not occur at a base layer but occurs at an enhancement layer in a same video frame, or a quantity, a proportion, a quantity of lost packets, or the like of video frames in which packet loss occurs at an enhancement layer. Because the network adopts a more robust transmission policy for base layer data, a probability of packet loss of enhancement layer data packet is higher. The UE takes statistics of one or more of information such as a quantity, a proportion, a quantity of lost packets, or the like of video frames in which packet loss does not occur at a base layer but occurs at an enhancement layer, and report the information to the base station. The base station adjusts the transmission policy of the enhancement layer according to the information.

The foregoing is described by using an example in which the video frame is divided into two layers: a base layer and an enhancement layer. In practice, the video frame is divided into three layers, four layers, or more layers. For example, the video frame is divided into three layers. The UE takes statistics of a quantity, a proportion, a quantity of lost packets, or the like of video frames in which packet loss does not occur at a base layer but occurs at a first enhancement layer, and a quantity, a proportion, a quantity of lost packets, or the like of video frames in which packet loss does not occur at the base layer but occurs at a second enhancement layer. The UE even reports a quantity, a proportion, a quantity of lost packets, or the like of video frames in which packet loss does not occur at the base layer or the first enhancement layer but occurs at the second enhancement layer, or the UE reports a quantity, a proportion, a quantity of lost packets, or the like of video frames in which packet loss does not occur at the base layer or the second enhancement layer but occurs at the first enhancement layer, or the UE reports a quantity, a proportion, a quantity of lost packets, or the like of video frames in which packet loss does not occur at the base layer but occurs at the first enhancement layer and the second enhancement layer simultaneously.

3. A plurality of parameters selected from a quantity, a proportion, a quantity of lost packets, or the like of video frames in which packet loss does not occur at an enhancement layer but occurs at a base layer in a same video frame, or a quantity, a proportion, a quantity of lost packets, or the like of video frames in which packet loss occurs at a base layer. The network adopts a more robust transmission policy for base layer data. Although the probability of this case is low, such case is able to occur. The UE reports this case to the base station, and the base station analyzes a cause of packet loss at the base layer according to the case, to optimize network deployment.

Similarly, the foregoing is described by using an example in which the video frame is divided into two layers: a base layer and an enhancement layer. In practice, the video frame is divided into three layers, four layers, or even more layers. Using an example in which a video frame is divided into three layers, the UE takes statistics of a quantity, a proportion, a quantity of lost packets, or the like of video frames in which packet loss does not occur at a first enhancement layer but occurs at a base layer. Alternatively, the UE takes statistics of a quantity, a proportion, a quantity of lost packets, or the like of video frames in which packet loss does not occur at a second enhancement layer but occurs at the base layer. Alternatively, the UE takes statistics of a quantity, a proportion, a quantity of lost packets, or the like of video frames in which packet loss does not occur at the first enhancement layer or the second enhancement layer but occurs at the base layer.

Optionally, a specific manner in which the UE reports the frame gap parameter, the packet loss parameter, the late parameter, or the base layer and enhancement layer parameters is similar to the foregoing manner in which the UE reports the spread delay parameter, and is not described in detail again.

The UE reports various video frame parameters by using a video frame as a granularity, so that the network more intuitively learns of the transmission status of the video frame, and optimizes a network algorithm.

The foregoing uses the spread delay as an example to describe the reporting condition. For a reporting condition of another parameter, refer to that of the spread delay.

Embodiment 2: Due to particularity of a video service, a network coding manner is used. Specifically, the base station performs network coding on data of the video service, and then transmit the data to the UE. The base station generally performs unified network coding on a plurality of data packets included in a video frame. In this case, a video frame parameter reported by the UE includes at least one of the following:

1. Spread Delay Parameter

A difference from the spread delay parameter in Embodiment 1 lies in that network coding is not performed on the video frame in Embodiment 1, and network coding is performed on the video frame in at least one embodiment. In some embodiments, after receiving the spread delay parameter, in response to the base station finding that the spread delay is excessively large and exceeds decoding duration of a general video decoder, the base station subsequently selects a proper time to send a first data packet of a subsequent video frame, to ensure that a last data packet of the video frame is sent within a proper spread delay.

2. Frame Gap Parameter

A difference from the frame gap parameter in Embodiment 1 lies in that network coding is not performed on the video frame in Embodiment 1, and network coding is performed on the video frame in at least one embodiment. In some embodiments, in response to the base station finding that the frame gap between the video frames is unstable, the base station subsequently increases a size of a buffer to ensure that the video frames are sent at a same interval.

3. Packet Loss Parameter

A difference from the packet loss parameter in Embodiment 1 lies in that network coding is not performed on the video frame in Embodiment 1, and network coding is performed on the video frame in at least one embodiment. In some embodiments, in response to the base station finding that there are a small quantity of video frames in which packet loss occurs, but once packet loss occurs, a plurality of packets are lost, the base station determines that a deep fading time of a wireless signal is long, and changes a new frequency band to send a video frame.

4. Base Layer and Enhancement Layer Parameters

A difference from the base layer and enhancement layer parameters in Embodiment 1 lies in that network coding is not performed on the video frame in Embodiment 1, and network coding is performed on the video frame in at least one embodiment. In some embodiments, in response to the base station finding that a time difference between a base layer and an enhancement layer of a same video frame is excessively large, a transmission interval between the two layers is reduced subsequently.

5. Data slice parameter: A video frame includes one or more data slices after network coding is performed, and the data slice parameter includes a parameter used for at least one of the following items.

A quantity and/or a data volume of data slices that the UE uses to receive to successfully decode a video frame.

After network coding is performed on the video frame, original data is redundant, and the data volume increases. The more redundancy, the higher the tolerance of a packet loss rate in network transmission, and the higher the requirement for the network transmission capacity. For example, a data packet of a video frame has a data volume of 1000 kilobits (Kbit) before network coding, and a data volume of 1500 kilobits (Kbit) after network coding. However, the UE receives 1200 kilobits (Kbit), and even in response to packet loss occurring in the middle, the UE still performs network decoding and successfully recover all data of the video frame. In this case, the UE reports a parameter indicating a data volume of data slices that the UE uses to receive to successfully decode a video frame, for example, “1200 kilobits are required to successfully perform network decoding”. Similarly, the UE reports a quantity of data slices that the UE uses to receive to successfully decode a video frame, for example, a parameter of “N data slices are required to successfully perform network decoding”. After obtaining the report information, the base station lowers a redundancy rate of network coding for subsequent video frames. In addition, to help the base station control the redundancy rate of network coding, the UE further takes statistics of and report “a data volume that uses to be received by the UE to successfully decode a video frame”. The UE reports a quantity or a data volume of data slices used for successfully decoding a single video frame, or reports an average value, a maximum value, a minimum value, a variance, or the like of a quantity or a data volume of data slices used for successfully decoding a plurality of video frames by the UE.

A quantity and/or a data volume of data slices that the UE uses to receive to successfully decode a base layer of a video frame.

A quantity and/or a data volume of data slices that the UE uses to receive to successfully decode an enhancement layer of a video frame.

As shown in FIG. 9, in the case of layered video encoding+network coding, the base station performs network coding for the base layer and the enhancement layer respectively. After receiving the base layer data, the UE takes statistics of a quantity or a data volume of data slices required for successfully decoding the base layer data, and report the quantity or the data volume. After receiving the enhancement layer data, the UE takes statistics of a quantity or a data volume of data slices required for successfully decoding the enhancement layer data, or the like. Certainly, the quantity or the data volume of the data slices is a quantity or a data volume of data slices used by a base layer or an enhancement layer of a single video frame, or is an average value, a maximum value, a minimum value, a variance, or the like of a quantity or a data volume of data slices required by base layers or enhancement layers of a plurality of video frames. This is not limited. Optionally, the base station adjusts the redundancy rate of the base layer or the enhancement layer in the network coding process according to the reporting status of the UE.

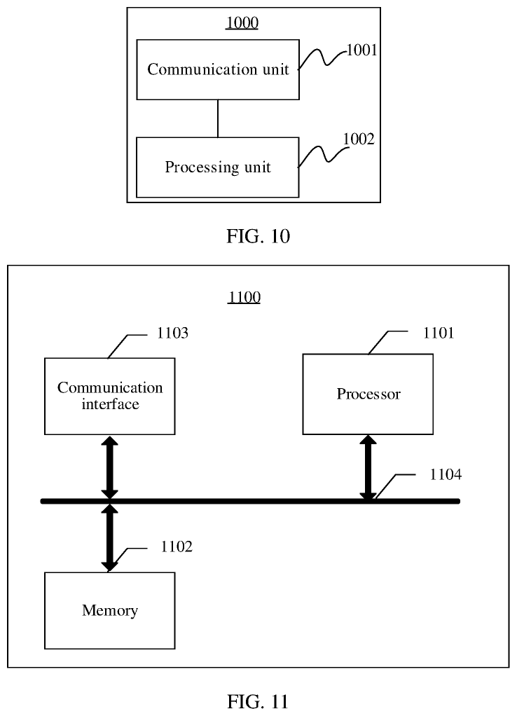

The method provided in at least one embodiment is described above in detail with reference to FIG. 1 to FIG. 9. An apparatus provided in at least one embodiment is described below in detail with reference to FIG. 10 and FIG. 11. The description of the apparatus embodiments corresponds to the description of the method embodiments. For content not described in detail in the apparatus embodiments, refer to the description in the foregoing method embodiments.

FIG. 10 is a schematic block diagram of an apparatus 1000 according to at least one embodiment. The apparatus is configured to implement functions of the terminal device or the network device in the foregoing methods. For example, the apparatus 1000 is a software unit or a chip system. The chip system includes a chip, or includes a chip and another discrete component. The apparatus includes a communication unit 1001, and further includes a processing unit 1002. The communication unit 1001 communicates with the outside. The processing unit 1002 is configured to perform processing. The communication unit 1001 is also referred to as a communication interface, a transceiver unit, an input/output interface, or the like.

In an example, the apparatus 1000 implements the steps performed by the terminal device in the foregoing embodiment. The apparatus 1000 is a terminal device, or a chip or a circuit configured in the terminal device. The communication unit 1001 performs sending and receiving operations in the foregoing embodiments, and the processing unit 1002 is configured to perform processing-related operations of the terminal device in the foregoing method embodiments.

For example, the communication unit 1001 is configured to receive at least one video frame from a network device; and the processing unit 1002 is configured to determine a video frame parameter based on the at least one video frame. The communication unit 1001 is further configured to send the video frame parameter to the network device.

Optionally, the video frame parameter includes at least one of the following: a spread delay parameter, a frame gap parameter, a packet loss parameter, a late parameter, and base layer and enhancement layer parameters.

Optionally, the spread delay parameter indicates at least one of the following: a spread delay of a first video frame, an average spread delay of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Optionally, the processing unit 1002 is further configured to determine whether packet data convergence protocol PDCP sequence numbers SNs of data packets included in a received video frame are consecutive; and determine that packet loss occurs in the video frame in response to PDCP SNs of the data packets included in the video frame received by the terminal device being non-consecutive.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

Optionally, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Optionally, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

In an example, the apparatus 1000 implements the steps performed by the network device in the foregoing method embodiments. The apparatus 1000 is a network device, or a chip or a circuit configured in the network device. The communication unit 1001 is configured to perform sending and receiving operations of the network device in the foregoing method embodiments, and the processing unit 1002 is configured to perform processing-related operations of the network device in the foregoing method embodiments.

For example, the communication unit 1001 is configured to send at least one video frame to a terminal device, where the communication unit 1001 is further configured to receive a video frame parameter from the terminal device, and the video frame parameter is determined based on the at least one video frame. Optionally, the processing unit 1002 is configured to optimize transmission of a downlink video frame according to the video frame parameter.

Optionally, the video frame parameter includes at least one of the following: a spread delay parameter, a frame gap parameter, a packet loss parameter, a late parameter, and base layer and enhancement layer parameters.

Optionally, the spread delay parameter indicates at least one of the following: a spread delay of a first video frame, spread delays of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

Optionally, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Optionally, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

In at least one embodiment, division into the units is an example, is merely division into logical functions, and is other division during actual implementation. In addition, functional units in at least one embodiment is integrated into one processor, or each of the units exist alone physically, or two or more units is integrated into one unit. The integrated unit is implemented in a form of hardware, or is implemented in a form of a software functional unit.

In the foregoing embodiment, functions of the communication unit is implemented by a transceiver, and functions of the processing unit is implemented by a processor. The transceiver includes a transmitter and/or a receiver, to respectively implement functions of a sending unit and/or a receiving unit. Descriptions are provided below by way of example with reference to FIG. 11.

FIG. 11 is a schematic block diagram of an apparatus 1100 according to at least one embodiment. The apparatus 1100 shown in FIG. 11 is an implementation of a hardware circuit of the apparatus shown in FIG. 10. The apparatus performs functions of the terminal device or the network device in the foregoing method embodiments. For ease of description, FIG. 11 only shows main components of the communication apparatus.

The communication apparatus 1100 shown in FIG. 11 includes at least one processor 1101. The communication apparatus 1100 further includes at least one memory 1102, configured to store program instructions and/or data. The memory 1102 is coupled to the processor 1101. The coupling in at least one embodiment is indirect coupling or a communication connection between apparatuses, units, or modules in an electrical form, a mechanical form, or another form, and is used for information exchange between the apparatuses, the units, or the modules. The processor 1101 cooperates with the memory 1102, the processor 1101 executes program instructions stored in the memory 1102, and at least one of the at least one memory 1102 is included in the processor 1101.

The apparatus 1100 further includes a communication interface 1103, configured to communicate with another device through a transmission medium, so that the communication apparatus 1100 communicates with the another device. In at least one embodiment, the communication interface is a transceiver, a circuit, a bus, a module, or a communication interface of another type. In at least one embodiment, in response to the communication interface being the transceiver, the transceiver includes an independent receiver and an independent transmitter, or is a transceiver integrated with a transceiver function, or is an interface circuit.

Connection media between the processor 1101, the memory 1102, and the communication interface 1103 are not limited in at least one embodiment. In at least one embodiment, in FIG. 11, the memory 1102, the processor 1101, and the communication interface 1103 are connected with each other through a communication bus 1104. The bus is represented by a thick line in FIG. 11, and connection manners of other components are merely for schematic descriptions and are not construed as a limitation. The bus includes an address bus, a data bus, a control bus, and the like. For ease of representation, only one thick line is used to represent the bus in FIG. 11, but this does not mean that there is only one bus or only one type of bus.

In an example, the apparatus 1100 is configured to implement the steps performed by the terminal device in the foregoing method embodiment. The communication interface 1103 is configured to perform sending and receiving related operations of the terminal device in the foregoing method embodiments, and the processor 1101 is configured to perform processing-related operations of the terminal device in the foregoing method embodiments.

For example, the communication interface 1103 is configured to receive at least one video frame from a network device; the processor 1101 is configured to determine a video frame parameter based on the at least one video frame; and the communication interface 1103 is further configured to send the video frame parameter to the network device.

Optionally, the video frame parameter includes at least one of the following: a spread delay parameter, a frame gap parameter, a packet loss parameter, a late parameter, and base layer and enhancement layer parameters.

Optionally, the spread delay parameter indicates at least one of the following: a spread delay of a first video frame, an average spread delay of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Optionally, the processor 1101 is further configured to determine whether packet data convergence protocol PDCP sequence numbers SNs of data packets included in a received video frame are consecutive; and determine that packet loss occurs in the video frame in response to PDCP SNs of the data packets included in the video frame received by the terminal device being non-consecutive.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

Optionally, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Optionally, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

In another example, the apparatus 1100 is configured to implement the steps performed by the network device in the foregoing method embodiments. The communication interface 1103 is configured to perform sending and receiving related operations of the network device in the foregoing method embodiments, and the processor 1101 is configured to perform processing-related operations of the network device in the foregoing method embodiments.

For example, the communication interface 1103 is configured to send at least one video frame to a terminal device, where the communication interface 1103 is further configured to receive a video frame parameter from the terminal device, and the video frame parameter is determined based on the at least one video frame. Optionally, the processor 1101 is configured to optimize transmission of a downlink video frame according to the video frame parameter.

Optionally, the video frame parameter includes at least one of the following: a spread delay parameter, a frame gap parameter, a packet loss parameter, a late parameter, and base layer and enhancement layer parameters.

Optionally, the spread delay parameter indicates at least one of the following: a spread delay of a first video frame, spread delays of a plurality of video frames, a maximum spread delay of a plurality of video frames, a minimum spread delay of a plurality of video frames, and a variance of spread delays of a plurality of video frames, where the spread delay is a time length from a time in response to the terminal device successfully receiving a first data packet of a video frame to a time in response to the terminal device successfully receiving a last data packet of the video frame, and the first video frame or the plurality of video frames are one or more video frames of the at least one video frame received by the terminal device.

Optionally, the frame gap parameter indicates at least one of the following: a frame gap between adjacent video frames, an average value of a plurality of frame gaps, a maximum value of a plurality of frame gaps, a minimum value of a plurality of frame gaps, and a variance of a plurality of frame gaps, where the terminal device receives a plurality of video frames from the network device.

Optionally, the packet loss parameter includes at least one of the following: a quantity of video frames in which packet loss occurs, and a proportion of video frames in which packet loss occurs, where packet loss occurs in K consecutive video frames, and K is a positive integer greater than or equal to 1.

Optionally, the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, and a variance of time differences between actual receiving moments and correct receiving moments of a plurality of late video frames.

Optionally, each video frame includes base layer data and enhancement layer data; and the base layer and enhancement layer parameters include at least one of the following: a time difference between a time in response to the terminal device receiving base layer data and a time in response to the terminal device receiving enhancement layer data in a second video frame, where the second video frame is a video frame in the at least one video frame; at least one of a quantity of third video frames, a proportion of third video frames, or a quantity of lost packets at an enhancement layer in a third video frame, where the third video frame is a video frame in which packet loss does not occur in base layer data but occurs in enhancement layer data, and the third video frame is a video frame in the at least one video frame; and at least one of a quantity of fourth video frames, a proportion of fourth video frames, or a quantity of lost packets at a base layer in a fourth video frame, where the fourth video frame is a video frame in which packet loss does not occur in enhancement layer data but occurs in base layer data, and the fourth video frame is a video frame in the at least one video frame.

Optionally, the video frame includes one or more data slices after network coding is performed, and the video frame parameter further includes at least one of the following: a quantity of data slices that the terminal device uses to receive to successfully decode a video frame and/or a data volume of the data slices; a quantity of data slices that the terminal device uses to receive to successfully decode a base layer of a video frame and/or a data volume of the data slices; and a quantity of data slices that the terminal device uses to receive to successfully decode an enhancement layer of a video frame and/or a data volume of the data slices.

Further, at least one embodiment further provides an apparatus, where the apparatus is configured to perform the method in the method embodiment in FIG. 5. A computer-readable storage medium is provided, including a program. In response to the program being run by a processor, the method in the foregoing method embodiment in FIG. 5 is performed. A computer program product is provided. The computer program product includes computer program code. In response to the computer program code being run on a computer, the computer is enabled to implement the method in the foregoing method embodiment in FIG. 5. A chip is provided, including a processor. The processor is coupled to a memory. The memory is configured to store a program or instructions. In response to the program or the instructions being executed by the processor, an apparatus is enabled to perform the method in the foregoing method embodiment in FIG. 5. A system is provided, including at least one of the terminal device and the network device that perform the foregoing method embodiments.

In at least one embodiment, the processor is a general-purpose processor, a digital signal processor, an application-specific integrated circuit, a field programmable gate array or another programmable logic device, a discrete gate or transistor logic device, or a discrete hardware component, and implements or execute the methods, steps, and logical block diagrams disclosed in at least one embodiment. The general purpose processor is a microprocessor or any conventional processor or the like. The steps of the method disclosed with reference to embodiments of this application is directly performed by a hardware processor, or is performed through a combination of hardware in the processor and a software module.

In at least one embodiment, the memory is a non-volatile memory, for example, a hard disk drive (HDD) or a solid-state drive (SSD), or is a volatile memory, for example, a random access memory (RAM). The memory is any other medium that carries or stores expected program code in a form of an instruction or a data structure and that is accessed by a computer, but is not limited thereto. The memory in at least one embodiment alternatively is a circuit or any other apparatus that implements a storage function, and is configured to store program instructions and/or data.

All or some of the methods in at least one embodiment are implemented through software, hardware, firmware, or any combination thereof. In response to software being used to implement the embodiments, all or a part of the embodiments are implemented in a form of a computer program product. The computer program product includes one or more computer instructions. In response to the computer program instructions being loaded and executed on the computer, the procedure or functions according to embodiments of the present invention are all or partially generated. The computer is a general-purpose computer, a dedicated computer, a computer network, a network device, user equipment, or another programmable apparatus. The computer instructions is stored in a computer-readable storage medium or is transmitted from a computer-readable storage medium to another computer-readable storage medium. For example, the computer instructions is transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium is any usable medium accessible by a computer, or a data storage device, such as a server or a data center, integrating one or more usable media. The usable medium is a magnetic medium (for example, a floppy disk, a hard disk, or a magnetic tape), an optical medium (for example, a digital video disc (DVD)), a semiconductor medium (for example, an SSD), or the like.

A person skilled in the art makes various modifications and variations without departing from the scope of at least one embodiment. At least one embodiment is intended to cover these modifications and variations provided that they fall within the scope of protection defined by the following claims and their equivalent technologies.

1. A communication apparatus, comprising:
a memory, configured to store a computer program, wherein
a processor configured to execute the computer program stored in the memory, to perform operations including:
receiving at least one video frame from a network device;
determining a video frame parameter based on the at least one video frame; and
sending the video frame parameter to the network device.

2. The apparatus according to claim 1, wherein the video frame parameter includes at least one of the following:
a spread delay parameter, a frame gap parameter, a packet loss parameter, a late parameter, or base layer and enhancement layer parameters.

3. The apparatus according to claim 2, wherein
the spread delay parameter indicates at least one of the following: a spread delay of a first video frame, an average spread delay of a plurality of video frames, a maximum spread delay of a plurality of video frames, a minimum spread delay of a plurality of video frames, or a variance of spread delays of a plurality of video frames, wherein the spread delay is a time length from a time when a first data packet of a video frame is successfully received to a time when a last data packet of the video frame is successfully received, and the first video frame or the plurality of video frames are one or more video frames of the at least one video frame received.

4. The apparatus according to claim 2, wherein
the frame gap parameter indicates at least one of the following: a frame gap between adjacent video frames, an average value of a plurality of frame gaps, a maximum value of a plurality of frame gaps, a minimum value of a plurality of frame gaps, or a variance of a plurality of frame gaps, wherein a plurality of video frames is received from the network device.

5. The apparatus according to claim 2, wherein the packet loss parameter includes at least one of the following: a quantity of video frames in which packet loss occurs, or a proportion of video frames in which packet loss occurs, wherein packet loss occurs in K consecutive video frames, and K is a positive integer greater than or equal to 1.

6. The apparatus according to claim 5, wherein the processor is further configured to perform operations for:
determining whether packet data convergence protocol (PDCP) sequence numbers (SNs) of data packets in a received video frame are consecutive; and
determining that packet loss occurs in the video frame when PDCP SNs of the data packets in the video frame received are non-consecutive.

7. The apparatus according to claim 2, wherein the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, or a variance of time differences between actual receiving moments and correct receiving moments of a plurality of late video frames.

8. The apparatus according to claim 2, wherein
each video frame includes base layer data and enhancement layer data; and
the base layer and enhancement layer parameters includes at least one of the following:
a time difference between a time when base layer data is received and a time when enhancement layer data is received in a second video frame, wherein the second video frame is a video frame in the at least one video frame;
at least one of a quantity of third video frames, a proportion of third video frames, or a quantity of lost packets at an enhancement layer in a third video frame, wherein the third video frame is a video frame in which packet loss does not occur in base layer data but occurs in enhancement layer data, and the third video frame is a video frame in the at least one video frame; and
at least one of a quantity of fourth video frames, a proportion of fourth video frames, or a quantity of lost packets at a base layer in a fourth video frame, wherein the fourth video frame is a video frame in which packet loss does not occur in enhancement layer data but occurs in base layer data, and the fourth video frame is a video frame in the at least one video frame.

9. The apparatus according to claim 1, wherein the video frame includes one or more data slices after network coding is performed, and the video frame parameter further includes at least one of the following:
a quantity of data slices that are to be received to successfully decode a video frame and/or a data volume of the data slices;
a quantity of data slices that are to be received to successfully decode a base layer of a video frame and/or a data volume of the data slices; or
a quantity of data slices that are to be received to successfully decode an enhancement layer of a video frame and/or a data volume of the data slices.

10. A communication apparatus, comprising:
a memory, configured to store a computer program; and
a processor configured to execute the computer program stored in the memory, to perform operations including:
sending at least one video frame to a terminal device; and
receiving a video frame parameter from the terminal device, wherein the video frame parameter is determined based on the at least one video frame.

11. The apparatus according to claim 10, wherein the video frame parameter includes at least one of the following:
a spread delay parameter, a frame gap parameter, a packet loss parameter, a late parameter, or base layer and enhancement layer parameters.

12. The apparatus according to claim 11, wherein
the spread delay parameter indicates at least one of the following: a spread delay of a first video frame, spread delays of a plurality of video frames, a maximum spread delay of a plurality of video frames, a minimum spread delay of a plurality of video frames, or a variance of spread delays of a plurality of video frames, wherein the spread delay is a time length from a time when the terminal device successfully receives a first data packet of a video frame to a time when the terminal device successfully receives a last data packet of the video frame, and the first video frame or the plurality of video frames are one or more video frames of the at least one video frame received by the terminal device.

13. The apparatus according to claim 11, wherein
the frame gap parameter indicates at least one of the following: a frame gap between adjacent video frames, an average value of a plurality of frame gaps, a maximum value of a plurality of frame gaps, a minimum value of a plurality of frame gaps, or a variance of a plurality of frame gaps, wherein the terminal device is sent a plurality of video frames.

14. The apparatus according to claim 11, wherein the packet loss parameter includes at least one of the following: a quantity of video frames in which packet loss occurs, or a proportion of video frames in which packet loss occurs, wherein packet loss occurs in K consecutive video frames, and K is a positive integer greater than or equal to 1.

15. The apparatus according to claim 11, wherein the late parameter indicates at least one of the following: a quantity of late video frames, a proportion of late video frames, a time difference between an actual receiving moment and a correct receiving moment of a late video frame, an average value of time differences between actual receiving moments and correct receiving moments of a plurality of late video frames, a maximum value of time differences between actual receiving moments and correct receiving moments of a plurality of late video frames, a minimum value of time differences between actual receiving moments and correct receiving moments of a plurality of late video frames, or a variance of time differences between actual receiving moments and correct receiving moments of a plurality of late video frames.

16. The apparatus according to claim 11, wherein
each video frame includes base layer data and enhancement layer data; and
the base layer and enhancement layer parameters includes at least one of the following:
a time difference between a time when the terminal device receives base layer data and a time when the terminal device receives enhancement layer data in a second video frame, wherein the second video frame is a video frame in the at least one video frame;
at least one of a quantity of third video frames, a proportion of third video frames, or a quantity of lost packets at an enhancement layer in a third video frame, wherein the third video frame is a video frame in which packet loss does not occur in base layer data but occurs in enhancement layer data, and the third video frame is a video frame in the at least one video frame; and
at least one of a quantity of fourth video frames, a proportion of fourth video frames, or a quantity of lost packets at a base layer in a fourth video frame, wherein the fourth video frame is a video frame in which packet loss does not occur in enhancement layer data but occurs in base layer data, and the fourth video frame is a video frame in the at least one video frame.

17. The apparatus according to claim 10, wherein the video frame includes one or more data slices after network coding is performed, and the video frame parameter further includes at least one of the following:
a quantity of data slices that the terminal device needs to receive to successfully decode a video frame and/or a data volume of the data slices;
a quantity of data slices that the terminal device needs to receive to successfully decode a base layer of a video frame and/or a data volume of the data slices; or
a quantity of data slices that the terminal device needs to receive to successfully decode an enhancement layer of a video frame and/or a data volume of the data slices.

18. A communication system, wherein the communication system includes a terminal device and a network device;
wherein the network device is configured to send at least one video frame to the terminal device; and
wherein the terminal device is configured to:
receive the at least one video frame from the network device;
determine a video frame parameter based on the at least one video frame; and
send the video frame parameter to the network device;
wherein the network device is further configured to receive the video frame parameter from the terminal device.

19. The communication system according to claim 18, wherein the video frame parameter includes at least one of the following:
a spread delay parameter, a frame gap parameter, a packet loss parameter, a late parameter, or base layer and enhancement layer parameters.

20. The communication system according to claim 18, wherein the video frame includes one or more data slices after network coding is performed, and the video frame parameter further includes at least one of the following:
a quantity of data slices that the terminal device needs to receive to successfully decode a video frame and/or a data volume of the data slices;
a quantity of data slices that the terminal device needs to receive to successfully decode a base layer of a video frame and/or a data volume of the data slices; or
a quantity of data slices that the terminal device needs to receive to successfully decode an enhancement layer of a video frame and/or a data volume of the data slices.
